(19) United States
(12) Patent Application Publication
(10) Pub. No.: US 2010/0133238 A1
(43) Pub. Date: Jun. 3, 2010

(54) Machining Fluid

(75) Inventors: Yao Yang Tsai, Taipei (TW); Chih-Kang Chang, Taipei (TW)

Correspondence Address: BEVER HOFFMAN & HARMS, LLP;901 Campisi Way, Suite 370, Campbell, CA, 95008, US

(73) Assignee: National Taiwan University, Taipei (TW)

(21) Appl. No.: 12/508,321

(22) Filed: Jul. 23, 2009

(30) Foreign Application Priority Data
Nov. 28, 2008 (TW) 097146435

(51) Int. Cl. B23H 1/08; B23H 1/00

(52) U.S. Cl. 219/69.14; 219/69.17

(57) ABSTRACT

A machining fluid is provided. A machining fluid for one of an electrical discharge machining process and an electrical discharge machining-polishing process, comprising a polymolecular powder, a hard particle and a carrier liquid, wherein a concentration of the polymolecular powder is lower than 500 g/L.

### FIELD OF THE INVENTION

The present invention relates to a machining fluid, in particular, to a machining fluid employed in an electrical discharge machining (EDM) process or an electrical discharge machining-polishing (EDMP) process.

### BACKGROUND OF THE INVENTION

An electrical discharge machining (EDM) process is one of the fully-developed methods and is also one of the most frequently used methods for mold manufacturing at present. During implementing the EDM process, a machining fluid is an indispensable media for duly implementing the EDM process. The main function of the machining fluid is to be an insulation among electrodes and work pieces and to carry away produced debris and to reduce the temperature of work pieces during the EDM process. But after machining by the EDM process, a lot of craters and micro-cracks are consequently formed on the surface of the work pieces due to the thermal impacts from sparks occurring during discharging period of the EDM process, or a recast layer that is also termed as a white layer will be formed on the machined surface since the melted surface of the work piece will be rapidly cooled down after discharging. These factors all render the machined surface of the work piece scarred and the surface roughness thereof will therefore become poor. Thus, the machined mold has still to be further polished after EDM process, in order to deal with the cracks and micro-cracks thereon.

In order to improve the surface machined by EDM process, some scholars try to apply a machining fluid mixed with various types of powders to add into the conventional EDM process, for example, adding aluminum powders, chromium powders, silica powders or aluminum oxide powders etc. Some researches propose to involve a polishing process after the conventional EDM process is finished as being an electrical discharge machining-polishing (EDMP) process. An electro-rheological fluid (ERF) is adopt as a machining fluid in EDMP process.

Please refer to FIG. 1, which is a diagram illustrating an EDMP machine for implementing the EDMP process. The EDMP machine 10 demonstrated in FIG. 1 includes a computer 101, an oscilloscope 102, a galvanometer 103, a power source 104, a control circuit 105, an actuator 12, an ERF 13, a work-piece 14 and an electrode 15. When implementing the EDMP, the control circuit 105 is first made contact with the power source 104. Then the positive current (+) and the negative current (−) are respectively applied to the electrode 15 and the work-piece 14. A voltage difference is formed between the electrode 15 and the work-piece 14 and an electrical field is subsequently formed therebetween. A gap whose size is in a range of 5 μm to 50 μm exists between the work-piece 14 and the electrode 15, wherein the actuator 12 is a motor or any other devices able to cause the electrode 15 to have the rotation. Typically, the work-piece 14 and the electrode 15 are immersed in the ERF 13, so that the work-piece 14 and the electrode 15 are enclosed by the ERF 13. The work-piece 14 is any thing whose surface is needed to be machined (the surface treatment) or polished, such as the cases of cell phones, of the digital cameras, of the personal digital assistant (PDAs) or of the 3rd generation media player (MP3) etc.

The actuator 12 is used for actuating the electrode 15 to proceed the symmetrical rotation, whereby the first and the second conductors are actuated such that the first and the second conductors are in a relative motion with respect to each other. In the period that the work-piece 14 and the electrodes 15 are in a relative motion with respect to each other, the magnitude of the voltage difference is controlled by the control circuit 105 in accordance with the demands, and collaterally the magnitude of the electrical field therebetween is varied. In most occasions, the variation of the magnitude of the electrical field is regularly alternated by increasing and decreasing the voltage difference. That is, the voltage difference would be regularly increased and decreased by a specified frequency scheme whereby the regular variation of the intensity of the electrical field is formed. More information revealing the technology of EDMP process is with reference to the patent application documents of US publication number US2008/0000584A1.

Although the surface roughness of work piece could be improved by this method, the craters and micro-cracks still remain left on the machined surface of work piece and the recast layer is still unable to be totally removed. Therefore, the improvements provided by EDMP process are restrictive yet.

To overcome the mentioned drawbacks of the prior art, a surface treatment method and device thereof are provided.

### SUMMARY OF THE INVENTION

In view of the defects existing in the prior art, this invention relates to a machining fluid including the polarizable polymolecular powders and the silicon oil so as to form a novel machining fluid that could be applied in both EDM and EDMP processes. The carrier liquid is mixed with the polymolecular powders to form as an ERF. Furthermore, the formed ERF is further mixed with the hard particles as abrasives to form as an electro-rheological polishing fluid (ERPF). Such ERF could be the machining fluid involved in the EDM or EDMP process and similarly the ERPF could be the machining fluid involved in the EDM or EDMP process. However, since as compared with the ERF, the ERPF has hard particles added in addition, the ERPF is preferably adopted in the EDMP process. After experimenting, it is proved that while adapting such machining fluid according to the present invention in the EDM or EDMP process, the amounts of craters and the micro-cracks on the machined surface is significantly decreased and the recast layer is neatly removed, so that the surface roughness of the work pieces is well refined and the quality of the work pieces is able to be remarkably upgraded.

According to the first aspect of the present invention, a machining fluid for one of an EDM process and an EDMP process, comprising a polymolecular powder, a hard particle and a carrier liquid, wherein a concentration of the polymolecular powder is lower than 500 g/L.

Preferably, the machining fluid further comprises an interface active agent.

Preferably, the polymolecular powder is a polarizable macromolecule material.

Preferably, the polymolecular powder is one selected from a group consisting of a starch, a cellulose, a polyaniline, a liquid crystal molecule and a combination thereof.

Preferably, the starch is one of a potato starch and a corn starch.

Preferably, the hard particle is one selected from a group consisting of an aluminum oxide particle, a silicon carbide particle, a diamond particle, a metal particle, an abrasive particle and a combination thereof.

Preferably, the carrier liquid is an oil-based or a non-hydrophilic liquid.

Preferably, the oil-based liquid is one selected from a group consisting of a silicone oil, an electrical discharge machining oil, a mineral oil, vegetable oil and a combination thereof.

Preferably, the carrier liquid is a water-based liquid.

Preferably, the water-based liquid is one selected from a group consisting of a distilled water, a tap water, a mineral water and a combination thereof.

Preferably, a weight ratio of the polymolecular powder to the hard particle is 1:1.

Preferably, the carrier liquid is a silicone oil, and the polymolecular powder and the hard particle both have a concentrations of 100 g/L.

Preferably, the carrier liquid is a silicone oil, and the polymolecular powder has a concentration of 200 g/L.

According to the second aspect of the present invention, an electrical discharge machining process utilizes the machining fluid as claimed.

According to the third aspect of the present invention, an electro-rheological fluid comprises a polymolecular powder and a carrier liquid, wherein a concentration of the polymolecular powder is lower than 500 g/L.

Preferably, the electro-rheological fluid is a material having a viscosity varying with an intensity of an electrical field.

The foregoing and other features and advantages of the present invention will be more clearly understood through the following descriptions with reference to the drawings:

### BRIEF DESCRIPTION OF THE DRAWINGS

FIG. 1 is a diagram illustrating an EDMP machine for implementing the EDMP process;

FIG. 2(a) is a diagram illustrating a surface of the work piece machined by a conventional machining fluid in a conventional EDM process;

FIGS. 2(b)˜2(d) are diagrams respectively illustrating different surface condition of work pieces machined by the starch-mixed ERPF according to the present invention in an EDMP process; and

FIGS. 3(a) and 3(b) are cross-sectional diagrams illustrating a white layer on the surface of the work piece.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only; it is not intended to be exhaustive or to be limited to the precise from disclosed.

The machining fluid according to the present invention mainly includes the polymolecular powders and carrier liquid. The carrier liquid is first mixed with the polymolecular powders to form as an electro-rheological fluid (ERF). Further, the formed ERF is mixed with hard particles to form as an electro-rheological polishing fluid (ERPF). The polymolecular powders, such as natural polymolecular powders or artificial polymolecular powders, are the powder having high dielectric constant that could be polarized by an external applied electrical field. The natural polymolecular powders are starch powders, cellulose powders or a combination thereof. The artificial polymolecular powders are polyaniline powders, liquid crystal molecules or a combination thereof. The polymolecular powders are used to form a polishing brush under an external applied electrical field to drive the aforementioned grinding particles to polish the surface of the work piece. The carrier liquid is an oil-based liquid or a non-hydrophilic liquid, such as a silicone oil, an electrical discharge machining oil, a mineral oil, vegetable oil and a combination thereof. The carrier liquid is also a water-based liquid, such as a distilled water, a tap water, a mineral water or a combination thereof. The hard particles, such as aluminum oxide particles, silicon carbide particles, diamond particles, metal particles, abrasive panicles and a combination thereof, are used as a grinding particle for polishing the surface of the work pieces. In addition, an interface active agent could be duly added into the above-mentioned formed ERF or ERPF.

That is, a first kind formula of the machining fluid according to the present invention is to form the ERF by adding the polarizable polymolecular powder into the carrier liquid. The ERF could be the machining fluid employed respectively in the EDM process. A second kind formula of the machining fluid according to the present invention is to form an ERPF by further adding the hard particles into the above-mentioned ERF. The ERPF could be the machining fluid employed in the EDM process or the EDMP process. While the external electrical field is applied to the ERPF in the EDMP machine, the aforementioned hard particles will be driven by the ERPF, so that the electrical discharge machining and a polishing step could be simultaneously achieved within the same procedure by the EDMP machine, which is termed as the EDMP process.

Composition of the Machining Fluid According to the Present Invention

⊚ Carrier Liquid

The GE Toshiba TSF451-50 oil is adopted as the silicon oil which has characteristics including broad range temperature adaptability, low viscosity temperature changes, well thermal stability, well chemical stability, low flammability, low surface tension and corrosion resistance.

The IDEMITSU 2028 electrical discharge machining oil with low viscosity is adopted as the electrical discharge machining oil which has advantages such as low volatility, high flash point, good anti-oxidability, tasteless and non-poisonous.

⊚ Hard Particles

The hard particles being the grinding particles are the aluminum oxide powders commonly used in the grinding relevant field. The aluminum oxide powders whose average diameter is 1 μm produced by EXTEC Company is adopted. Other materials such as silicon carbide particle or a diamond particle could also be used as the grinding particles.

⊚ Polymolecular Powders

Polyaniline (PANI) powders or starch powders are adopted as the polarizable polymolecular powders in the present invention, so as to form the ERF or the ERPF.

(1) PANI

The PANT produced Aldrich company is adopted in this invention. There are two kinds of PANI, Polyaniline emeraldine base (PANI-base) and Polyaniline emeraldine salt (PANI-salt). The PANI-base is a nonconductor, but the PANI-salt is the conductor. PANI has characteristics such as easy to be synthesized, high stability and wide range of work temperature. Furthermore, electrical properties of PANI can be straightforwardly adjusted by controlling the concentration of the proton acid doped therein. Thus the PANI is quite suitable for being used for forming the ERF or the ERPF.

There are three kinds of type patterns to PANI, including complete oxidation pattern (leucoemeraldine), partial oxidation pattern (emeraldine), complete reduction pattern (pernigraniline). Wherein the partial oxidation pattern could be categorized as emeraldine base and emeraldine salt. The emeraldine base is adopted to form the ERF or the ERPF in this invention, since the emeraldine base performs better than the emeraldine slat and emeraldine base is the only pattern that can conduct electric.

(2) Starch

The starch adopted in this invention is the generally maize starch. The starch has characteristic as great dielectric constant, great viscosity and great molecular weight (Mw). The starch is a kind of natural macromolecule, which is a kind of polysaccharides that is made up of glucose. The starch can be categorized into amylose and amylopectin. The amylose is apt to be hydrolyzed which has straight-chain molecules and lower viscosity. The amylopectin is not apt to be hydrolyzed which has branched-chain molecules and larger viscosity.

The properties of various macromolecules powder adopted in this invention are shown in Table 1 as follows.

TABLE 1
Properties of various macromolecules powders

| | macromolecules | | | |
|---|---|---|---|---|
| Properties | PANI-base | PANI-base | PANI-salt | Starch |
| Molecular structures | 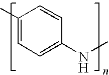 | 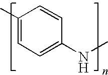 | 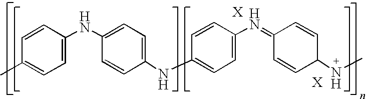 | 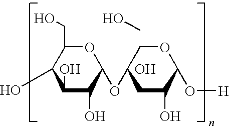 |
| Molecular | 20000 | 65000 | >15000 | 10⁷~10⁹ |
| weight | | | | |
| (Mw) | | | | |
| Dielectric | <10 | <10 | unknown | 2-200 |
| constant | | | | |
| Con- | No | No | Yes | No |
| ductive | | | | |

⊚Interface Active Agent

Due to the influence caused by the ERF, the effects of machining are consequently different. Therefore, an interface active agent is added into the ERPF that consists of ERF and hard particles to reduce the surface tension between the carrier liquid and the grinding particles, whereby the arching effect among grinding particles in the ERF, to render the polishing brushes formed by the polymolecular powders better. Furthermore, adding the interface active agent can also reduce the viscosity of the machining fluid, render it smoother drain away the debris, so that the machining speed could be increased.

The interface active agents Span20 and Span80, which has a minimum irritability to the environments, produced by Sigma company are adopted in the present invention.

The Effect of Implementation

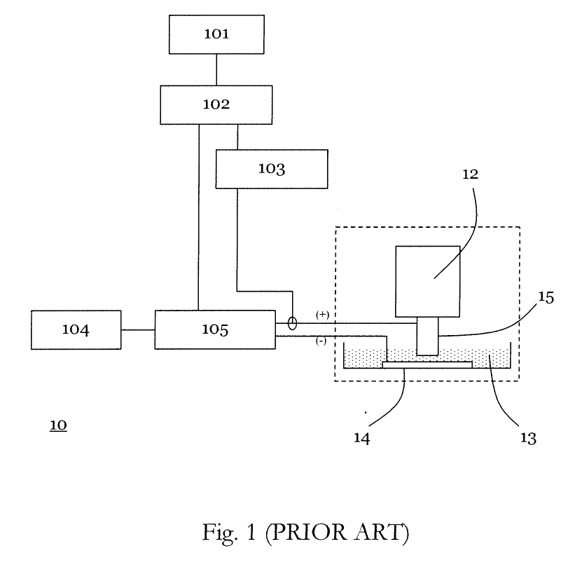

The device used for implementing EDMP has already illustrated in the FIG. 1. A copper electrode is used as the electrode 15 of EDMP machine 10, since it has low consumptivity while electric discharging. The work piece is SUS304 stainless steel. The size of the work piece is about 50 mm×15 mm×2 mm. The relevant machining parameters used for implementing EDMP are shown in Table 2 as follows.

TABLE 2
Machining parameters

| Machining Parameters | Work Conditions |
|---|---|
| Electrode | Copper (−) |
| Piece | Stainless Steel (SUS304) (+) |
| Circuit | RC circuit |
| Voltage | 250 V |
| Resistor | 1000Ω |
| Capacity | 0.01 Mf |

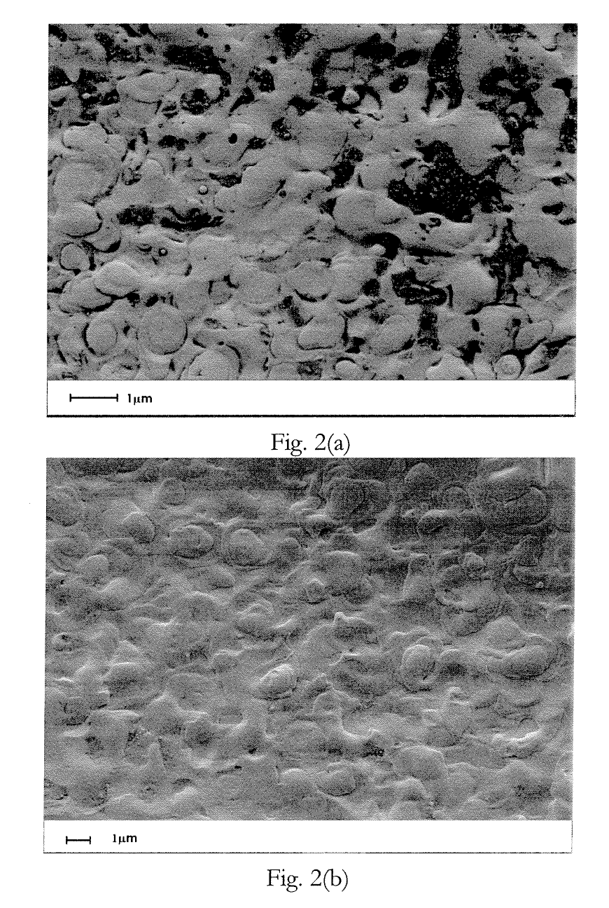

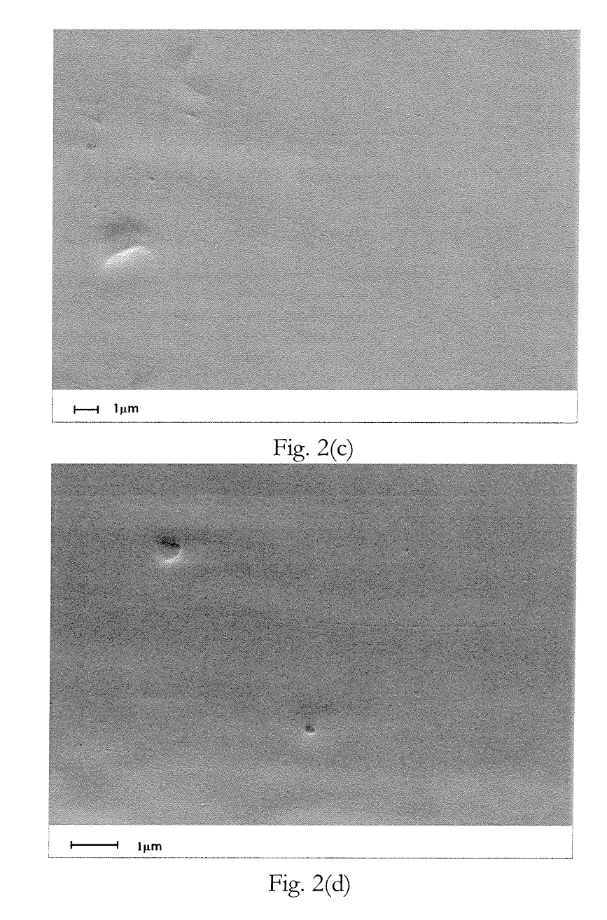

Regarding the effect for adapting the ERF or ERPF in the EDM or EDMP process, please refer to FIGS. 2(a)˜2(d). FIG. 2(a) is a diagram illustrating a surface of the work piece machined by a conventional machining fluid in a conventional EDM process. FIGS. 2(b)˜2(d) are diagrams respectively illustrating different surface condition of work pieces machined by the starch-mixed ERPF according to the present invention in an EDMP process. In order to observe the surface of the work piece, a scanning electron microscope (SEM) is utilized to observe the surface of the work piece in detail. In FIG. 2(a), it is apparent that the surface machined by the conventional EDM process is still scarred with ugly craters. In FIG. 2(b), the starch whose concentration is 10 g/L (ratio of weights/volume) is adopted as the polymolecular powders. It is clearly demonstrated in FIG. 2(b) that there is quite good progressive to the surface roughness but still a few craters caused by the high voltage discharging over the machined surface. The surface roughness of the machined surface in FIG. 2(b) is about Ra 0.76 μm. However, while the concentration of the starch is increased to 50 g/L or 100 g/L, it is found that the craters over the machined surface are significantly decreased as that respectively shown in FIGS. 2(c) and 2(d). The surface roughness of the machined surfaces in respective FIGS. 2(b) and 2(d) are about Ra 0.12 μm and Ra 0.10 μm. In FIGS. 2(b) and 2(d), except some minor polishing traces, the machined surfaces therein are extremely smooth and are as a mirror. It is resulted from being duly polished by the polishing brush made of the polymolecular powders and grinded by the hard particles. There is an exquisite 86% percents improvement to the surface roughness for the surface machined by the ERPF according to the present invention as compared with that machined by the conventional one, while the ERPF according to the present invention is applied to machine the surface of work piece.

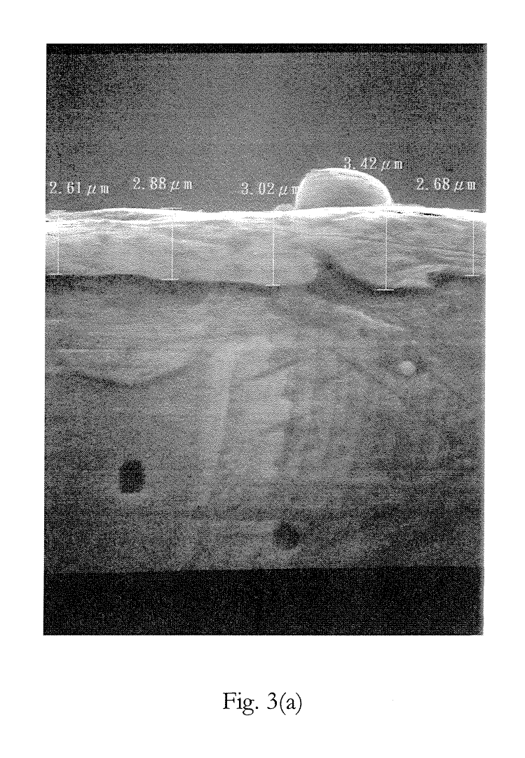

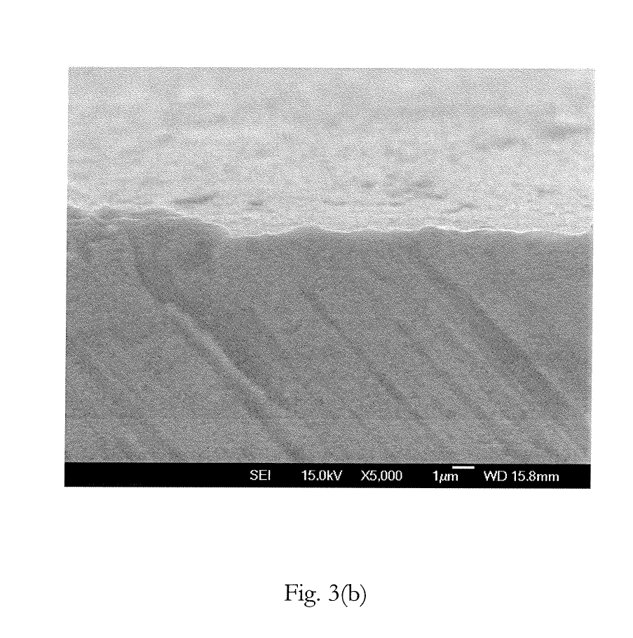

Please keep referring to FIGS. 3(a) and 3(b), which are cross-sectional diagrams illustrating a white layer on the surface of the work piece. FIG. 3(a) is a diagram illustrating a surface of the work piece machined by a conventional purely silicon oil in a conventional EDM process. The thickness of the white layer shown in FIG. 3(a) is about 2.92 μm. FIG. 3(b) is a diagram illustrating a surface of the work piece machined by the starch-mixed ERPF according to the present invention in an EDMP process. In FIG. 3(b), it is clearly demonstrated that due to the polishing and grinding effects by the ERPF according to the present invention, the white layer formed after discharging is perfectly eliminated. There is none of white layer formed on the machined surface of the work piece and the machined surface is excellently smooth as shown in FIG. 3(b).

It is further found that while the carrier liquid is a silicone oil and the polymolecular powders and the hard particles both have a concentration of 100 g/L, that is a weight ratio of the polymolecular powder to the hard particle is 1:1, a very excellent polishing effect could be obtained. The ERPF according to the present invention not only could remove the about 3 μm recast layer that is formed on the surface machined by a conventional electrical discharge machining oil, but also tremendously improves the surface roughness from Ra 0.69 μm to Ra 0.10 μm, which has a up to 86%-percent improvement to the surface roughness, reaching to the surface roughness about the sub-micrometer scaling. Besides, a concentration of the polymolecular powders should not be too large, it is suggested that a concentration of the polymolecular powder should be lower than 500 g/L. It is also found that while the polymolecular powders and the hard particles both have a concentration of 200 g/L, a fine machined surface could be obtained. Besides, since a minor quantity of silicon element is doped in the machined surface during the EDMP process, the hardness and the anti-corrosiveness of the machined surface will be enhanced. Therefore, such a novel machining fluid according to the present invention is able to perfectly improve the defects existing in the conventional machining fluid and to enhance the effect of EDM process, so that the quality of the work pieces is able to be remarkably upgraded.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

What is claimed is:

1. A machining fluid for one of an electrical discharge machining process and an electrical discharge machining-polishing process, comprising a polymolecular powder, a hard particle and a carrier liquid, wherein a concentration of the polymolecular powder is lower than 500 g/L.

2. The machining fluid according to claim 1 further comprising an interface active agent.

3. The machining fluid according to claim 1, wherein the polymolecular powder is a polarizable macromolecule material.

4. The machining fluid according to claim 1, wherein the polymolecular powder is one selected from a group consisting of a starch, a cellulose, a polyaniline, a liquid crystal molecule and a combination thereof.

5. The machining fluid according to claim 4, wherein the starch is one of a potato starch and a corn starch.

6. The machining fluid according to claim 1, wherein the hard particle is one selected from a group consisting of an aluminum oxide particle, a silicon carbide particle, a diamond particle, a metal particle, an abrasive particle and a combination thereof.

7. The machining fluid according to claim 1, wherein the carrier liquid is an oil-based or a non-hydrophilic liquid.

8. The machining fluid according to claim 7, wherein the oil-based liquid is one selected from a group consisting of a silicone oil, an electrical discharge machining oil, a mineral oil, vegetable oil and a combination thereof.

9. The machining fluid according to claim 1, wherein the carrier liquid is a water-based liquid.

10. The machining fluid according to claim 9, wherein the water-based liquid is one selected from a group consisting of a distilled water, a tap water, a mineral water and a combination thereof.

11. The machining fluid according to claim 1, wherein a weight ratio of the polymolecular powder to the hard particle is 1:1.

12. The machining fluid according to claim 1, wherein the carrier liquid is a silicone oil, and the polymolecular powder and the hard particle both have a concentrations of 100 g/L.

13. The machining fluid according to claim 1, wherein the carrier liquid is a silicone oil, and the polymolecular powder has a concentration of 200 g/L.

14. An electrical discharge machining process utilizing the machining fluid as claimed in claim 1.

15. An electro-rheological fluid, comprising a polymolecular powder and a carrier liquid, wherein a concentration of the polymolecular powder is lower than 500 g/L.

16. The electro-rheological fluid according to claim 15 being a material having a viscosity varying with an intensity of an electrical field.
